(19) United States
(12) Patent Application Publication
(10) Pub. No.: US 2019/0065607 A1
(43) Pub. Date: Feb. 28, 2019

(54) AUTOMATED APPLICATION ANALYTICS

(71) Applicant: Facebook, Inc., Menlo Park, CA (US)

(72) Inventors: Lisa Jones, Seattle, WA (US); Ramkumar Natarajan, Redmond, WA (US); Jonjo Twist, Redmond, WA (US)

(21) Appl. No.: 15/688,796

(22) Filed: Aug. 28, 2017

(51) Int. Cl. G06F 17/30; G06Q 50/00; G06Q 30/02

(52) U.S. Cl. CPC G06F 17/30867; G06Q 50/01; H04L 51/32; G06F 17/30702; G06F 17/30017; G06Q 30/0255

(57) ABSTRACT

An application analytics generation system employs data stored in a social networking system's social graph to automatically predict outcomes based on various observed attributes, and transmit these predictions to a social networking system's user interface, e.g., in a newsfeed, for an advertiser or application developer. These predictions correlate various attributes and/or actions to outcomes, e.g., in relation to advertisements or applications.

### BACKGROUND

Various analytics tool exist to assist business decision makers in making decisions based on data, e.g., observations. As an example, advertisers may want to know which advertising campaigns are successful and which are not. Even more useful are tools that can predict success of advertising campaigns, e.g., by correlating audiences and campaign assets (e.g., advertisements) with historical successes. As an example, an advertiser may want to know whether a particular advertisement would cause a particular viewer to complete a particular action (e.g., buy a product).

Similarly, software application developers may desire to understand what aspects of a user's attributes are likely to result in a preferred outcome. As an example, a user whose mobile computing device has a particular processor, amount of memory, and network communications speed (“computing resources”) may be more likely to use a particular feature of an application than a different user having inferior computing resources.

In particular, as the popularity of social networking has grown, social networking sites have attracted billions of users across the world. These users spend an immense amount of time interacting with content on social media websites. On one popular social network website, for example, active users spend a total of over 120 million hours each year interacting with the website.

Providing advertising content and/or application features that users are likely to find helpful or relevant increases the chances that users will interact with that content and those features, and that they will return to the website in the future. However, determining what factors to use to predict desirable (or undesirable) outcomes has traditionally been difficult.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations.

FIG. 5 is an a user interface diagram illustrating aspects of the disclosed user interface.

### DETAILED DESCRIPTION

Embodiments are described for automatically generating application analytics, e.g., in a social networking system. An application analytics generation system employs data stored in a social networking system's social graph to automatically predict outcomes based on various observed attributes, and transmit these predictions to a social networking system's user interface, e.g., in a newsfeed, for an advertiser or application developer.

An application analytics generation system collects data, e.g., from a social networking application, or retrieves previously collected data. The collected data includes at least a portion of a social graph corresponding to the social networking system. The social graph can be implemented as a data structure representing entities, relationships between the entities, attributes associated with the entities, and events corresponding to actions performed on or by the entities. The application analytics generation system can then correlate the attributes and actions with outcomes. The outcomes can be other attributes or actions. Examples of attributes can be, e.g., attributes of a user (e.g., gender, age group, demographic information), attributes stored in the social graph corresponding to the user (e.g., associations or interactions with other users, computing device information, interactions with entities, etc.), actions taken on or by the user, etc. An entity in a social graph can be a user, a page, a post, an image, a uniform resource locator, or indeed any other virtual item that can be identified by a node in a social graph. Examples of outcomes can be, e.g., selecting an advertisement, purchasing a product, installing an application, uninstalling an application, or engaging with a feature of an application.

Upon receiving a request for correlation data, the application analytics generation system can provide automatically determined correlations between attributes and outcomes. In various embodiments, the application analytics generation system can automatically analyze and generate correlations at various times, or can generate the correlations after receiving a request. In various embodiments, the application analytics generation system can receive the request via an application program interface or a user interface.

To automatically determine the correlations, the application analytics generation system can divide one or more sets of attributes and events not selected as outcomes into a set of dimensions, group the dimensions into two or more groups of dimensions, correlate the groups of dimensions with the outcomes, select at least one statistically significant correlation between one of the groups of dimensions and the outcomes, and then identify at least one correlation.

In various embodiments, to identify a statistically significant correlation, the application analytics generation system can perform a t-test between the two or more groups of dimensions. Various techniques are known in the art to identify statistical correlation and indeed, in various embodiments, the application analytics generation system can be capable of being configured for use with any of those techniques.

In various embodiments, the application analytics generation system can cause the identified at least one correlation to be displayed in a user interface of the social networking system, e.g., in a “newsfeed” or other user interface element. The user interface may also enable a user to provide an indication of whether the displayed at least one correlation is useful, e.g., using thumbs-up or thumbs-down icons. In various embodiments, the application analytics generation system can identify multiple correlations, prioritize the correlations (e.g., based on confidence analyses), and display the correlations in decreasing order of confidence.

In various embodiments, the application analytics generation system can use one or more machine learning algorithms to improve subsequent selections of selected correlations. As an example, after identifying several correlations and receiving user input on which correlations are more useful, the application analytics generation system can use machine learning to tune future correlations. In alternate embodiments, the application analytics generation system can may use one or more machine learning algorithms instead of statistical analyses.

In various embodiments, the application analytics generation system can receive from a user via a user interface a selection of a portion of the user interface defining a set of entities having common attributes and, in response, display via the user interface a set of additional entities also having the common attributes. As an example, a user may select a particular gender, geographic location, or memory capacity of a computing device and the application analytics generation system can display additional users or other entities sharing the selected attributes. As previously described, attributes can be, e.g., age, gender, country, operating system type, operating system version, screen size, memory capacity, type of data communications network employed, or one or more actions performed on or by an entity.

The application analytics generation system can sort the dimensions, e.g., in decreasing order of occurrence.

In various embodiments, a social graph can include a set of nodes (representing social networking system objects, also known as social objects) interconnected by edges (representing interactions, activity, or relatedness). Each node is associated with an “entity.” A social networking system entity can be a social networking system user, nonperson entity, content item, group, social networking system page, location, application, subject, concept or other social networking system object, e.g., a movie, a band, a book, etc. Content items can be any digital data such as text, images, audio, video, links, webpages, minutia (e.g. indicia provided from a client device such as emotion indicators, text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g. longitude/latitude, country, region, city, etc.), education information, life stage, relationship status, name, a model of devices typically used, languages identified as ones the user is facile with, occupation, contact information, or other demographic or biographical information in the user's profile page. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with nonperson objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users; can enable a user to post a message to the user's wall or profile or another user's wall or profile; can enable a user to post a message to a group or a fan page; can enable a user to comment on an image, wall post or other content item created or uploaded by the user or another user, etc. In least one embodiment, a user posts a status message to the user's profile indicating a current event, state of mind, thought, feeling, activity, or any other present-time relevant communication. A social networking system can enable users to communicate both within and external to the social networking system. For example, a first user can send a second user a message within the social networking system, an email through the social networking system, an email external to but originating from the social networking system, an instant message within the social networking system, and an instant message external to but originating from the social networking system. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In at least one embodiment, users who belong to a common network are considered connected. For example, users who attend a common school, work for a common company, or belong to a common social networking system group can be considered connected. In at least one embodiment, users with common biographical characteristics are considered connected. For example, the geographic region users were born in or live in, the age of users, the gender of users and the relationship status of users can be used to determine whether users are connected. In at least one embodiment, users with common interests are considered connected. For example, users' movie preferences, music preferences, political views, religious views, or any other interest can be used to determine whether users are connected. In at least one embodiment, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Social networking users may have a “newsfeed,” which is a user interface showing various updates. These updates can include posts by other users, advertisements for products, status information regarding games or other applications associated with the user's social network, etc. Advertisers and game developers often desire to increase the interaction between users and the advertisements or software applications that are shown in their newsfeed. The disclosed application analytics generation system is capable of displaying to advertisers and software developers what attributes of various entities result in the outcomes the advertisers and developers desire.

Several embodiments of the described application analytics generation system are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

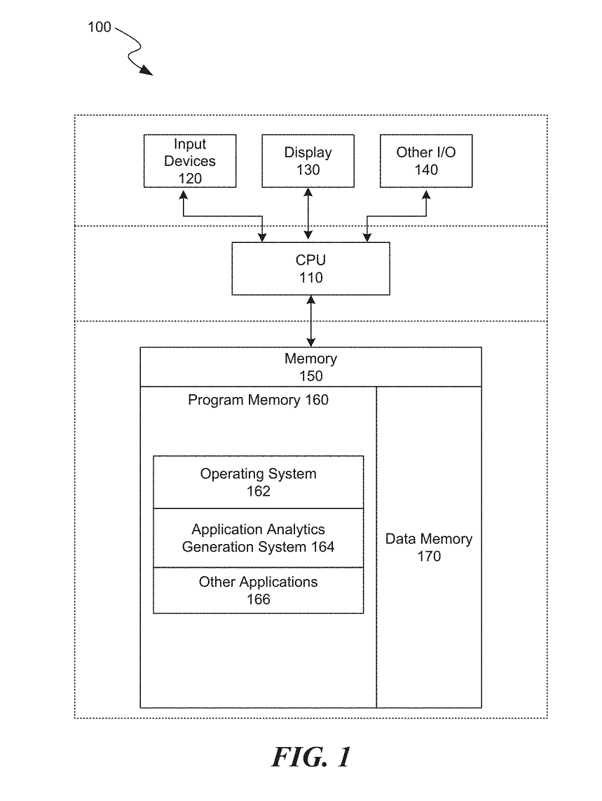

Turning now to the figures, FIG. 1 is a block diagram illustrating an overview of devices on which some implementations of the disclosed technology can operate. The devices can comprise hardware components of a device 100 that generates a ranked list of client engagement tools. Device 100 can include one or more input devices 120 that provide input to the CPU (processor) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus.

The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as an operating system 162, application analytics generation system 164, and other application programs 166. Memory 150 can also have data memory 170 that can include log data of user activities in various stages of client engagement with corresponding outcomes, client engagement tools, business rules, client engagement tool estimated benefit values, configuration data, settings, user options or preferences, etc., which can be provided to the program memory 160 or any element of the device 100.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

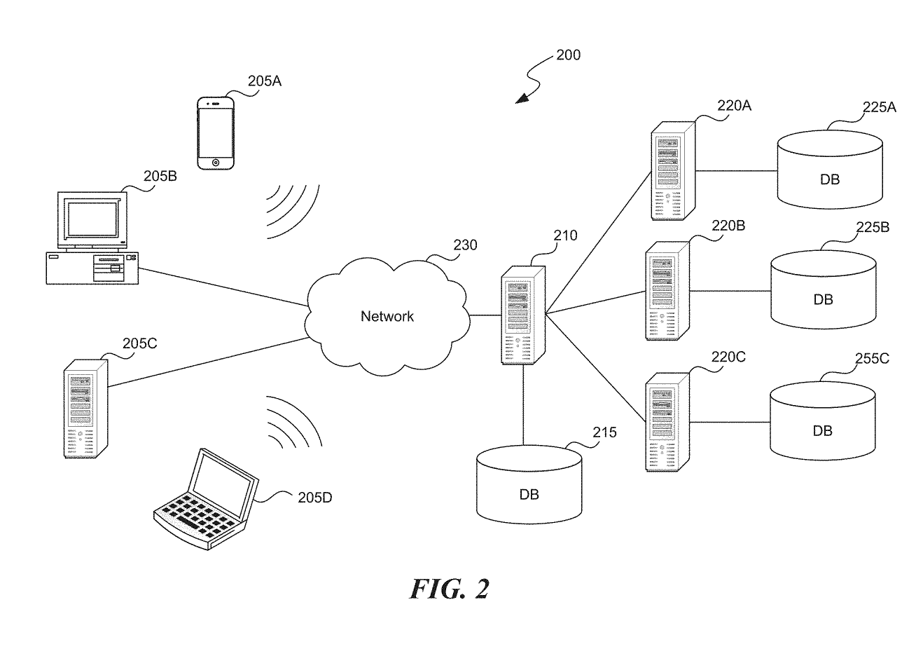

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections 210 through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database.

Databases 215 and 225 can warehouse (e.g. store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

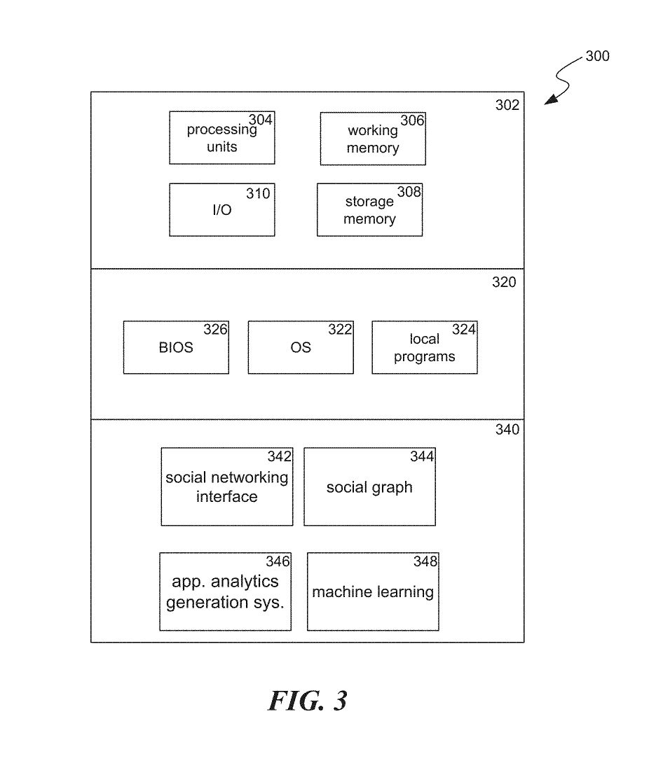

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308, and input and output devices 310. Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324.

The specialized components 340 can include a social networking user interface 342, social graph 344, application analytics generation system 346, and machine learning component 348. In various embodiments, the illustrated components may operate on multiple (e.g., hundreds or even thousands) of computing devices even though for the sake of simplicity of explanation they are illustrated and discussed below in relation to a single computing device.

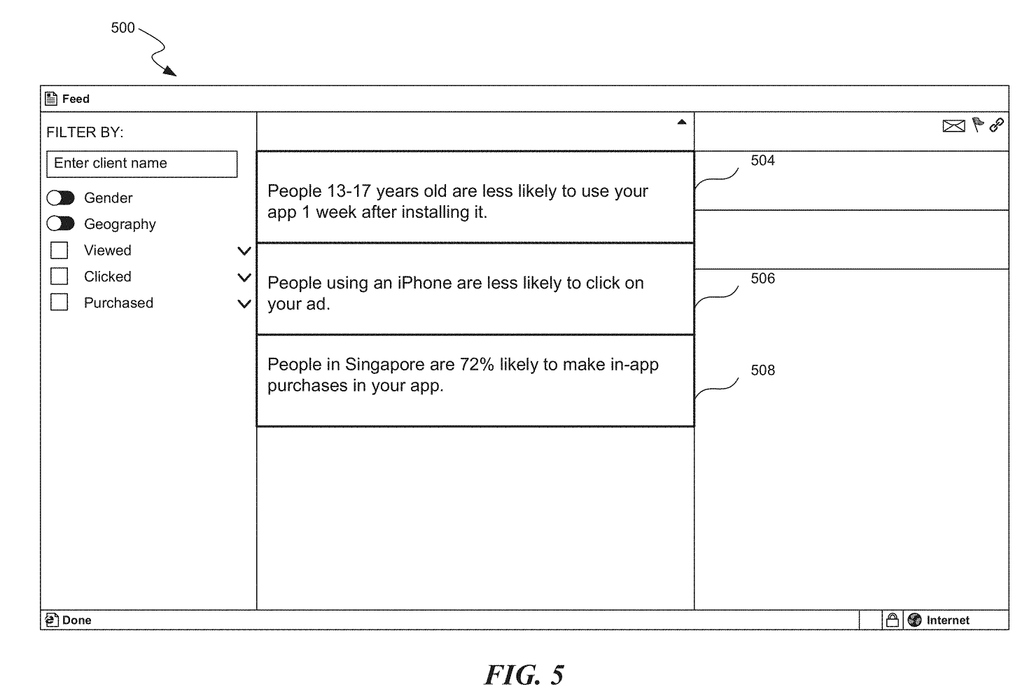

The social networking interface 342 is a user interface that can enable users to interact with a social networking system. The interface 342 also provides a “newsfeed” that is described in further detail below in relation to FIG. 5.

The social graph 344 is a data structure that stores pertinent information relation to the social networking system, e.g., entities, associations between entities, actions, events, attributes, etc.

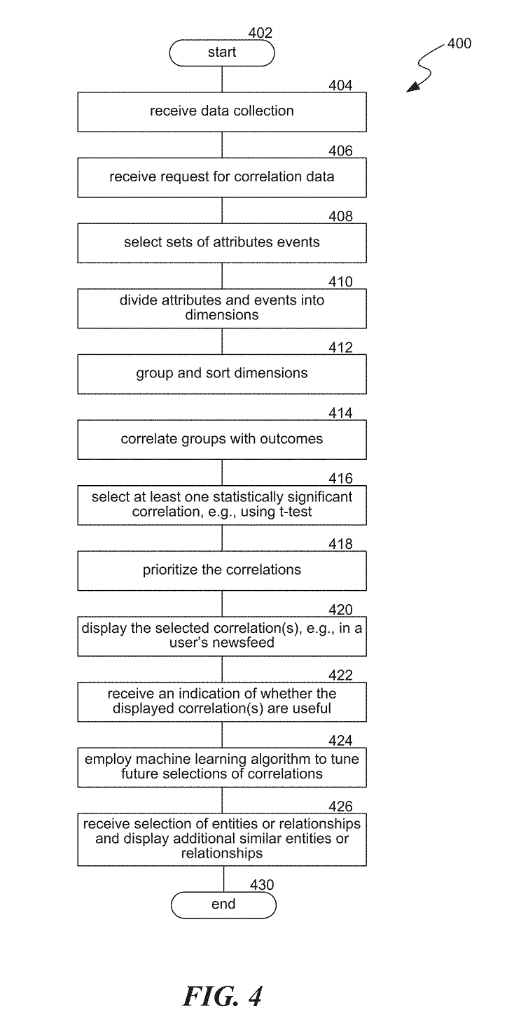

The application analytics generation system component 346 implements various aspects of the disclosed application analytics generation system. As an example, the component 346 can implement the process described below in relation to FIG. 4. The application analytics generation system 346 also provides an application program interface (not illustrated). The application program interface (API) can be invoked by various other components, e.g., various other local programs 324.

The machine learning component 348 can be employed by the application analytics generation system 346, e.g., to tune identified correlations as previously described.

FIG. 4 is a flow diagram illustrating a process used in some implementations. The process begins at block 402.

At block 404, the process receives a collection of data. The process can collect the data, e.g., from a social networking application, or retrieve previously collected data. The collected data includes at least a portion of a social graph corresponding to the social networking system. The social graph can be implemented as a data structure representing entities, relationships between the entities, attributes associated with the entities, and events corresponding to actions performed on or by the entities.

At block 406, the process receives a request for correlation data, e.g., via an API or a user interface. The process can then correlate the attributes and actions with outcomes. The outcomes can be other attributes or actions. Examples of attributes can be, e.g., attributes of a user (e.g., gender, age group, demographic information), attributes stored in the social graph corresponding to the user (e.g., associations or interactions with other users, computing device information, interactions with entities, etc.), actions taken on or by the user, etc. An entity in a social graph can be a user, a page, a post, an image, a uniform resource locator, or indeed any other virtual item that can be identified by a node in a social graph. Examples of outcomes can be, e.g., selecting an advertisement, purchasing a product, installing an application, uninstalling an application, or engaging with a feature of an application.

At block 408, the process selects sets of attributes and events. In various embodiments, attributes and events are values associated with entities (e.g., nodes of a social graph) and relationships (e.g., edges between nodes of the social graph). Outcomes can similarly be entities or relationships, but are those entities and/or relationships that are not in one or more of the selected sets of attributes and events. Thus the outcomes are “selected” by exception (i.e., because they are not in the selected sets of attributes and events).

At block 410, the process divides one or more sets of attributes and events into a set of dimensions. All entities and relationships that belong to a particular dimension share one or more attributes and/or events.

At block 412, the process groups the dimensions into two or more groups and sorts the groups, e.g., in decreasing order of number of items (e.g., entities and/or relationships) or number of dimensions in the groups.

At block 414, the process can correlate the groups of dimensions (e.g., the groups with the largest number of items or dimensions) with the outcomes, e.g., by selecting at block 416 at least one statistically significant correlation between one of the groups of dimensions and the outcomes, and then identify the at least one correlation. In various embodiments, the process may employ various known statistical techniques to perform this correlation, e.g., t-test, Wilcoxon rank-sum test, the Mann-Whitney U test, etc.

At block 418, the routine can prioritize the correlations, e.g., in decreasing order of confidence. As examples, the statistical techniques identified above may inherently provide confidence values based on their numerical outputs indicating correlations strengths.

At block 420, the process can cause the identified correlations, e.g., in a user's newsfeed (described below in relation to FIG. 5). In various embodiments, the application analytics generation system can cause the identified at least one correlation to be displayed in a user interface of the social networking system, e.g., in a “newsfeed” or other user interface element.

At block 422, the process can receive indications of which correlations are useful or not useful, e.g., by receiving ranking information from users, receiving “thumbs-up” or “thumbs-down” indications, etc.

At block 424, the process can employ various known machine learning algorithms to tune future selections of correlations. As examples, the machine learning algorithm can be given as inputs dimensions, outcomes, and user ranking information.

At block 426, the process can receive selections of entities or relationships (e.g., attributes or actions) and can display additional entities or relationships that are similar.

At block 430, the process ends. Those skilled in the art will appreciate that the logic illustrated in FIG. 4 and described above may be altered in various ways. For example, the order of the logic may be rearranged, substeps may be performed in parallel, illustrated logic may be omitted, other logic may be included, etc.

FIG. 5 is an a user interface diagram illustrating aspects of the disclosed user interface. The illustrated user interface 500 has a newsfeed area displaying three news items. News item 504 indicates that “People 13-17 years old are less likely to use your app 1 week after installing it.” This correlation insight includes an age range of attributes (13-17 years old) and a time range (1 week). The outcome is usage of the app. In this example, the system has automatically determined using the process described above in relation to FIG. 4 that a particular set of attributes (age and time ranges) is highly correlated with a particular outcome (app usage).

News item 506 indicates that “People using an iPhone are less likely to click on your ad.” This correlation insight includes a device attribute (iPhone), an advertisement attribute, a click action, and app usage as an outcome.

News item 508 indicates that “People living in Singapore are 72% likely to make in-app purchases in your app.” This correlation insight includes a demographics attribute (in Singapore) and in-app purchase as an outcome.

A user can select various attributes or actions in the user interface to identify additional similar entities or relationships.

Because there are millions or even billions of possible dimensions (e.g., device type, click actions, geography, etc.), a human operator would only be able to guess at possible correlations, but the system is capable of analyzing a vastly higher number and identify correlations that human operators can easily miss.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by a computing device having one or more processors and memories, comprising:
receiving a collection of data, wherein the received collection of data includes at least a portion of a social graph, the social graph comprising a data structure representing entities, relationships between the entities, attributes associated with the entities, and events corresponding to actions performed on or by the entities;
receiving, via an application program interface, a request for correlation data, the correlation data correlating the attributes and the actions with outcomes, wherein the outcomes are selected other attributes or actions;
dividing a set of attributes and events not selected as outcomes into a set of dimensions;
grouping the dimensions into two or more groups of dimensions;
correlating the groups of dimensions with the outcomes;
selecting at least one statistically significant correlation between one of the groups of dimensions and the outcomes; and
causing to be displayed in a user interface the selected at least one correlation.

2. The method of claim 1, wherein the selecting includes performing a t-test between the two or more groups of dimensions to select the at least one statistically significant correlation.

3. The method of claim 1, further comprising receiving from the user interface an indication of whether the displayed at least one correlation is useful.

4. The method of claim 3, further comprising using a machine learning algorithm to improve subsequent selections of selected correlations.

5. The method of claim 1, wherein the displaying is in a newsfeed of a social network.

6. The method of claim 5, further comprising:
selecting multiple correlations;
prioritizing the selected multiple correlations; and
displaying the selected multiple correlations in order of priority.

7. The method of claim 1, further comprising receiving via the user interface a selection of a portion of the user interface, the selected portion defining a set of entities having common attributes and, in response, displaying via the user interface a set of additional entities also having the common attributes.

8. The method of claim 1, further comprising sorting the groups of dimensions.

9. The method of claim 1, wherein the attribute can be age, gender, country, operating system type, operating system version, screen size, memory capacity, or type of data communications network employed.

10. The method of claim 1, wherein an attribute can be one or more actions performed on or by an entity.

11. The method of claim 1, wherein outcome can be selecting an advertisement, purchasing a product, installing an application, uninstalling an application, or engaging with a feature of an application.

12. A computer-readable storage device storing instructions, the instructions comprising:
instructions for receiving a collection of data, wherein the received collection of data includes at least a portion of a social graph, the social graph comprising a data structure representing entities, relationships between the entities, attributes associated with the entities, and events corresponding to actions performed on or by the entities;
instructions for receiving, via an application program interface, a request for correlation data, the correlation data correlating the attributes and the actions with outcomes, wherein the outcomes are selected other attributes or actions;
instructions for dividing a set of attributes and events not selected as outcomes into a set of dimensions;
instructions for grouping the dimensions into two or more groups of dimensions;
instructions for correlating the groups of dimensions with the outcomes;
instructions for selecting at least one statistically significant correlation between one of the groups of dimensions and the outcomes; and
instructions for causing to be displayed in a user interface the selected at least one correlation.

13. The computer-readable storage device of claim 12, wherein the instructions for selecting include instructions for performing a t-test between the two or more groups of dimensions to select the at least one statistically significant correlation.

14. The computer-readable storage device of claim 12, further comprising instructions for receiving from the user interface an indication of whether the displayed at least one correlation is useful.

15. The computer-readable storage device of claim 14, further comprising instructions for using a machine learning algorithm to improve subsequent selections of selected correlations.

16. The computer-readable storage device of claim 16, further comprising:
instructions for selecting multiple correlations;
instructions for prioritizing the selected multiple correlations; and
instructions for displaying the selected multiple correlations in order of priority.

17. The computer-readable storage device of claim 12, further comprising instructions for receiving via the user interface a selection of a portion of the user interface, the selected portion defining a set of entities having common attributes and, in response, displaying via the user interface a set of additional entities also having the common attributes.

18. The computer-readable storage device of claim 12, wherein the attribute can be age, gender, country, operating system type, operating system version, screen size, memory capacity, or type of data communications network employed.

19. The computer-readable storage device of claim 12, wherein outcome can be selecting an advertisement, purchasing a product, installing an application, uninstalling an application, or engaging with a feature of an application.

20. A system having one or more processors and memories, comprising:
a component configured to receive a collection of data, wherein the received collection of data includes at least a portion of a social graph, the social graph comprising a data structure representing entities, relationships between the entities, attributes associated with the entities, and events corresponding to actions performed on or by the entities;
a component configured to receive, via an application program interface, a request for correlation data, the correlation data correlating the attributes and the actions with outcomes, wherein the outcomes are selected other attributes or actions;
a component configured to divide a set of attributes and events not selected as outcomes into a set of dimensions;
a component configured to group the dimensions into two or more groups of dimensions;
a component configured to correlate the groups of dimensions with the outcomes;
a component configured to select at least one statistically significant correlation between one of the groups of dimensions and the outcomes; and
a component configured to cause to be displayed in a user interface the selected at least one correlation.
